(19) United States
(12) Patent Application Publication
(10) Pub. No.: US 2012/0194876 A1
(43) Pub. Date: Aug. 2, 2012

(54) Document Reader Including a Positioning and Retention System

(75) Inventors: Michael J. Moore, Beverly Hills, MI (US); John C. Gudenburr, Canton, MI (US); Sammy C. Hutson, Novi, MI (US); William J. Basse, Northville, MI (US)

(73) Assignee: Burroughs Payment Systems, Inc., Plymouth, MI (US)

(21) Appl. No.: 13/344,361

(22) Filed: Jan. 5, 2012

Related U.S. Application Data
(63) Continuation of application No. 11/903,854, filed on Sep. 25, 2007, now abandoned.

(51) Int. Cl. H04N 1/04

(52) U.S. Cl. 358/470; 358/488; 358/474

(57) ABSTRACT

A document scanner is disclosed. The document scanner includes a document bed having a document positioning surface. The document bed has a plurality of perforations therethrough. The document scanner also includes a fan mounted to the document bed on a side opposite the document positioning surface and oriented to draw air through the perforations of the document bed. A method of use of the document scanner, and a particular check scanner are disclosed as well.

### REFERENCE TO RELATED APPLICATION

This application is a continuation application of U.S. Ser. No. 11/903,854 filed on Sep. 25, 2007, now abandoned.

### TECHNICAL FIELD

The present disclosure relates to a document positioning and retention system. More particularly, the present disclosure relates to a document positioning and retention system for a document reader, such as a check scanning device.

### BACKGROUND

A transfer of funds can lag a business transaction, such as a purchase, by many days if a check or other negotiable instrument is used. This is because routing information must be read and processed, and the document must be transferred to a bank for funds to be exchanged. This time lag, or “float”, represents a substantial amount of time after transactions occur in which funds may accrue interest. It is therefore advantageous to companies or institutions accepting checks as a form of payment to process those checks as soon as possible after a transaction occurs to accrue this interest.

It can be advantageous to electronically read routing information on checks and also to scan checks or other documents representing a purchase in such a scenario. Modern scanning equipment, such as flatbed scanners, include a moveable scanning mechanism which passes along the length of the document. The scanning mechanism is guided at a constant speed along the length of the document by a linear rod. The document to be scanned is isolated from the scanning mechanism by a transparent panel. This is because if the document moves during the scanning process, the resulting scanned image can be skewed such that it becomes unreadable.

In check reading systems and other negotiable instrument scanners, a magnetic character reader contacts the document directly. In such systems, the friction occurring between the character reader and the document causes the document to move, and therefore causes skew when the document is scanned.

For these and other reasons, improvements are desirable.

### SUMMARY

In accordance with the present disclosure, the above and other problems are solved by the following:

In a first aspect, a document scanner is disclosed. The document scanner includes a document bed having a document positioning surface. The document bed has a plurality of perforations therethrough. The document scanner also includes a fan mounted to the document bed on a side opposite the document positioning surface and oriented to draw air through the perforations of the document bed.

In a second aspect, a method of operating a manual check scanner is disclosed. The method includes placing a document on a document positioning surface of a document bed, the document bed having a plurality of perforations. The method also includes activating at least one fan mounted to the document bed on a side opposite the document positioning surface, the fan oriented to draw air through the perforations of the document bed, thereby maintaining the document on the document positioning surface.

In a third aspect, a manually operable check scanner is disclosed. The check scanner includes a document bed having a check positioning surface, the document bed having a plurality of perforations. The check scanner also includes at least one fan mounted to the document bed on a side opposite the check positioning surface and oriented to draw air through the perforations of the document bed. The check scanner includes a slider bar mounted along the length of the document bed. The check scanner further includes a scanner module mounted to the slider bar. The scanner module is manually slidable along the length of the document bed. The fan is operable to create a pressure differential, holding a document to the check positioning surface.

### BRIEF DESCRIPTION OF THE DRAWINGS

FIG. 1 is a schematic depiction of a network in which an electronic financial transaction may be placed, in accordance with the present disclosure;

FIG. 2 shows a perspective schematic view of a document scanning system according to a possible embodiment of the present disclosure; and

FIG. 3 is a side plan view of the document reader of FIG. 2.

### DETAILED DESCRIPTION

Various embodiments of the present disclosure will be described in detail with reference to the drawings, wherein like reference numerals represent like parts and assemblies throughout the several views. Reference to various embodiments does not limit the scope of the invention, which is limited only by the scope of the claims attached hereto. Additionally, any examples set forth in this specification are not intended to be limiting and merely set forth some of the many possible embodiments for the claimed invention.

In general, the present disclosure relates to a document positioning and retention system for a document reader, such as a check scanning device. The document positioning and retention system described herein is useable in low-cost electronic document readers placed at locations for commercial transactions, such as restaurants, supermarkets, or other commercial businesses. The document reader itself provides a low-cost solution allowing businesses to capture check information for immediate transmittal to financial institutions. This reduces the time required to reliably communicate check information to financial institutions, and also reduces the time required to complete funds transfer.

The document positioning and retention system described in the present disclosure provides a simple methodology for securing a document to a surface to allow the document to be electronically read by a document reader. By document reader, it is intended that any of a number of types of document scanning devices are incorporated which can capture image or text data of a printed document for electronic storage and transmission.

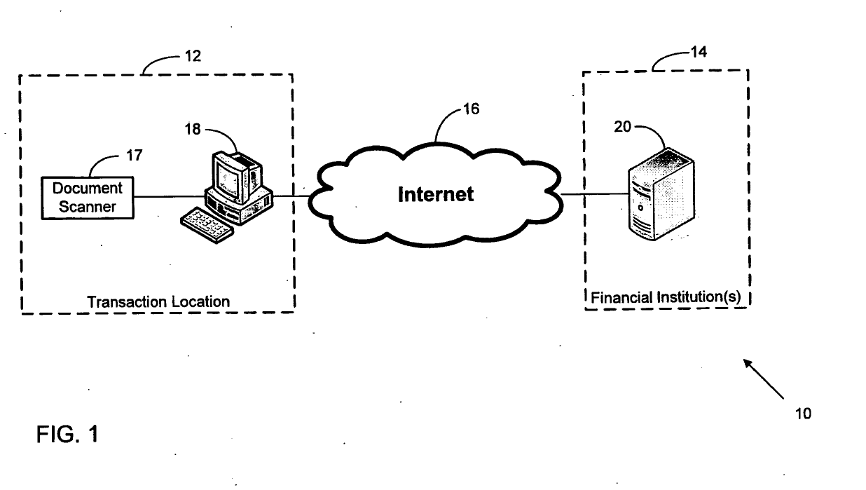

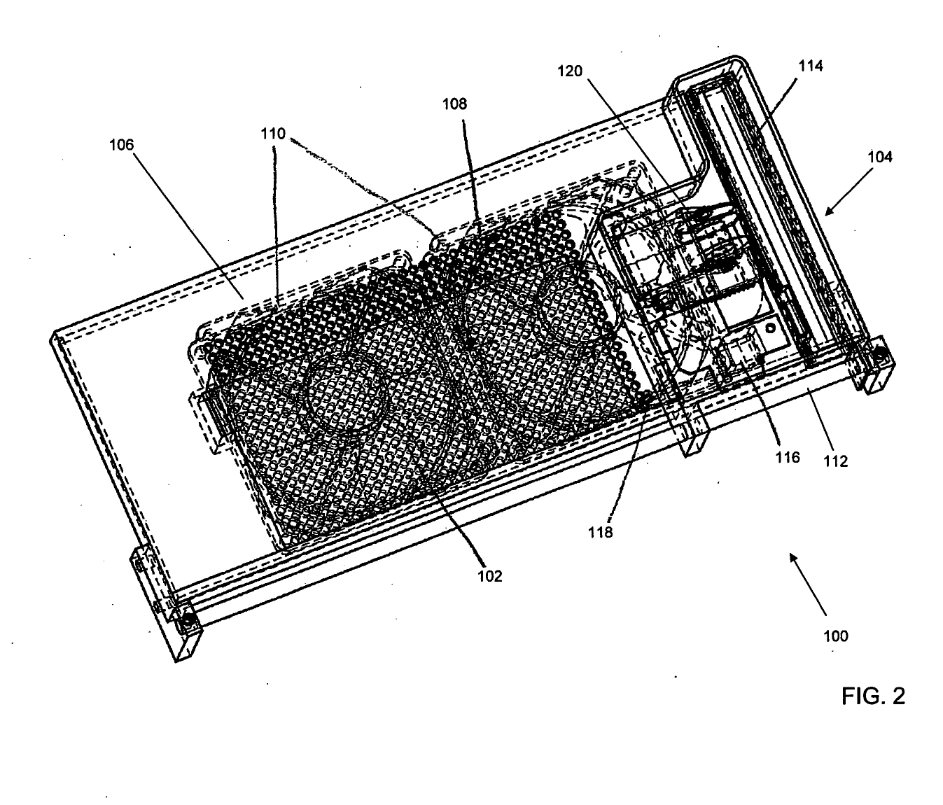

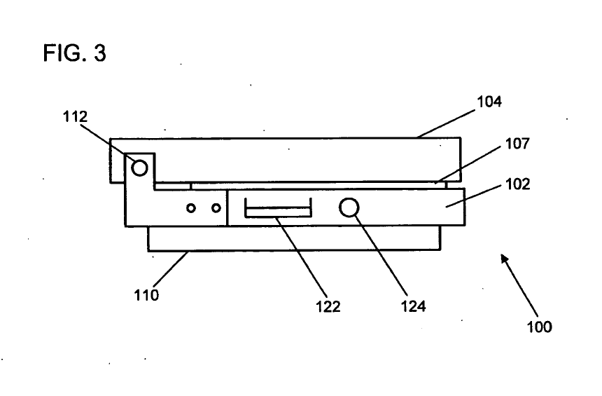

One specific example of a system incorporating a document reader or scanner having the disclosed document positioning and retention system is shown in FIG. 1. Specifically, FIG. 1 illustrates a schematic view of a network 10 in which a financial transaction may take place, according to a possible embodiment of the present disclosure. The network 10 generally includes one or more transaction locations 12 and financial institutions 14, communicatively connected by a network, shown as an internet connection 16. A transaction location 12 may be any of a number of places of business at which a financial transaction may take place, such as for purchase or sale of goods and services. Example transaction locations may include restaurants, supermarkets, or other places of business. Each transaction location includes a document scanner 17 interconnected with a computing system 18. The document scanner 17 is arranged to provide the transaction location with the ability to electronically acquire information about a printed document, such as a check used for payment in exchange for goods and/or services. In certain embodiments, the document scanner 17 can be a check scanner, which is sized and designed to be a low cost solution to read account information on personal checks and scan images of one or both sides of the check. An example document scanner useable in the network 10 is described below in conjunction with FIGS. 2-3.

The computing system 18 can be any of a number of types of computing systems, such as a general purpose personal computer, or a specialized computer such as a cash register or inventory system. The computing system 18 can interconnect with the document scanner 17 by any of a number of standard or specialized communication interfaces, such as a USB, 802.11 a/b/g network, RF, infrared, serial, or other data connection. In certain embodiments, the computing system 18 runs an application configured to control the document scanner 17; in further embodiments, the computing system receives data from the document scanner and stores and/or communicates the data (images, text, or other information) to other systems-to which it is interconnected.

Each of the financial institutions 14 generally includes a computing system 20, which is configured to receive electronic records of financial transactions relevant to the financial institutions. The computing system 20 can be any of a number of types of computing systems capable of storing and managing financial transactions; in the embodiment shown, the computing system is a server system comprising one or more discrete computing units interconnected, as is known in the art.

The electronic records can be electronic transaction records, and can include scanned copies of documents memorializing financial transactions. In a particular example, an electronic record can reflect a purchase made with a check, in which the electronic record includes the relevant information on the face of the check, the routing and institution number printed on the check, and an image of one or more sides of the check, used to validate the other information and to display relevant endorsements of the check. Other electronically captured transactions, such as credit card transactions, contracts, or other negotiable instrument transactions may be tracked using the network 10 as well.

The interne connection 16 depicted can be any of a number of WAN, LAN, or other packet based communication networks such that data can be shared among a number of computing systems or other networked devices. Furthermore, although in the embodiment shown two computing devices 18, 20 at different, specific locations are depicted, the computing devices and/or the document scanner 17 may be located at the same location or within the same network.

Referring now to FIG. 2, a document reader 100 is shown according to a possible embodiment of the present disclosure. The document reader 100 is generally a document scanning system which can be used to obtain text and image information about a document. The reader 100 generally includes a document bed 102 and a scanner module 104. The document bed 102 is made from a high-friction material, such as a rubber or high-friction plastic material, which assists in maintaining the position of a check or other document on the bed 102. The bed 102 includes a surface 106 sized to receive the document received in a financial transaction, such as a check written as payment.

The document bed 102 also includes perforations 108 running through it, from the document positioning surface 106 toward a side of the bed 102 opposite the surface. In the embodiment shown, the perforations 108 are of uniform size and sufficiently sized to allow passage of air therethrough without deforming checks or other documents placed on the document positioning surface 106. However, the perforations 108 can be any of a variety of sizes, or may be of different sizes.

One or more fans 110 are mounted opposite to the document positioning surface 106. The fans 110 are oriented to pull air from the side of the bed 102 of the document positioning surface 106, through the perforations 108. In the embodiment shown, two fans 110 are located on an underside of the bed 102. Other configurations of fans with respect to differing sized beds 102, surfaces 106, or perforations 108 are possible as well.

The fans 110 are selectively activated, when a document is placed on the document positioning surface 106, to assist with holding the document on the surface 106. The fans 110, in combination with the perforations 108, create a Bernoulli effect through the perforations, with suction holding the document flat against the surface 106 when activated. In one embodiment, a document sensor activates the fans 110. In a further embodiment, an on/off switch activates the fans. Other embodiments having additional activation systems, or combinations thereof, are possible as well.

In the embodiment shown, a slider bar 112 is mounted along an edge of the document positioning surface 106. The slider bar 112 provides a mounting location for the scanner module 104, allowing the module to slide along the length of the surface 106. Although in the embodiment shown a single slider bar is incorporated into the system, in various other embodiments additional slider bars or other mechanisms for guiding the scanner module 104 across the document positioning surface 106 may be incorporated into the system 100.

The scanner module 104 includes a contact image sensor 114, a magnetic character reader 116, an activation sensor 118, and a radial encoder 120. The contact image sensor 114 includes a linear scan element which can be used to scan an image of a document placed under it. The sensor 114 is passed across a document, such as a check, on the surface 106. In the embodiment shown, the contact image sensor 114 is arranged to pass 0.010 inch from the surface 106, allowing a document to pass closely thereunder. The data gathered by the contact image sensor 114 can be combined with position or speed information to transform data collected by the contact image sensor 114 into an image. The image can be communicated from the reader 100 to other computing systems (not shown) by way of a communications interface, such as a network interface. Additionally, the image can be stored in a memory managed by circuitry incorporated into the document reader 100 or interfaced thereto.

The magnetic character reader 116 reads magnetic characters printed on a check or other document. The magnetic character reader 116 is placed at a location. An example of a magnetic character read by the reader 116 includes the account number and routing number information printed on the front of a check or deposit slip. Other magnetically printed information may be read by the reader 116 as well, and can be stored or communicated in a similar fashion to the image captured by the contact image sensor 114, above.

The activation sensor 118 detects the presence of a document under the scanner module 104. In general, the activation sensor 118 senses the presence of a document on the surface 106, such as by detecting a change in the surface or color of the surface under the sensor 118. The sensor 118 is located on a leading edge of the scanner module 104, and transmits a signal to activate various other portions of the system 100, such as the contact image sensor 114 and the magnetic character reader 116. The activation sensor 118 can also optionally activate the fans 110 and radial encoder 120 upon detecting the presence of a document. Therefore, as the scanning components of the scanner module 104 pass over the documents, they have recently been activated. Once the activation sensor detects the end of the document, it can deactivate the scanning elements 114, 116 and the fans 110. In the embodiment shown, the activation sensor 118 is a photo sensor; other types of sensors may be incorporated as well.

The radial encoder 120 detects the speed of movement of the scanner module 104 along the surface 106. The radial encoder 120 includes a rotating element having a plurality of discrete indicators, such as differential colors or physical characteristics, which may be detected by circuitry to detect speed of the scanner module 104 by determining the rate of rotation of the radial encoder 120. The speed of the scanner module 104 is used by the document reader 100 to formulate a proper scanned image using the contact image sensor 114 and to properly read magnetic characters using the magnetic character reader 116. Other embodiments of the document reader 100 are possible as well, in which position or speed of the scanner module 104 can be detected by way of other mechanisms beyond the radial encoder. One example of such a system is described in U.S. patent application Ser. No. 11/903,944, filed on Sep. 25, 2007, and entitled “Document Reader Including An Optical Movement Detection System”, the disclosure of which is hereby incorporated by reference in its entirety.

FIG. 3 is a side plan view of the document reader 100, and shows the vertical layout of the various components of the document reader. In the system as shown, a document 107 resides on the document bed 102. The scanner module 104, mounted to the document bed 102 by the slider bar 108, rests on the document 107 such that it extends across the width of the document. The side of the scanner module 104 is preferably a low-friction surface including the various required scanning/reading components; as previously described; The document positioning surface 106 (seen in FIG. 2, above), as previously mentioned, is preferably a high-friction surface able to maintain the position of the document 107 as the scanner module 104 passes across it to scan the images/text on the document.

The fans 110 are mounted beneath the bed 102, such that perforations in the bed (shown in FIG. 2, above) pass through the bed to reach the location of the fans 110 in the region below the document 107. When the fans 110 are activated and a document 107 is placed on the bed 102, the fans draw the document toward the bed, ensuring that the document is securely held flat against the document bed during the scanning process.

The document reader 100 includes a communication connection 122 and a power connection 124. The communication connection 122 provides an interconnection location for connecting the document reader to an external computing system, such as the computing system 18 of FIG. 1. In the embodiment shown, the communication connection 122 is a USB connection; however, other types of communication interfaces may be used, such as a serial connection, RJ-45 or other packet-based wired connection system, Bluetooth, IR, RF, or other connection systems. The power connection 124 receives a power connector, such as an AC or DC power connection configured to provide electrical power to the various scanning components of the document reader 100. Although the document reader 100 is shown as having both a communication connection 122 and power connection 124, in certain embodiments, power to the reader 100 can be supplied by the communication connection, such as in the case of a USB or Firewire connection. Other types of connections may allow for power delivery over a communications interface as well. Furthermore, in the embodiment shown, the communication connection 122 and power connection 124 are located on a side of the document bed 102; in other embodiments, the connections can be located on a different side of the bed or on a side of the scanner module 104.

Referring to the document positioning and retention system for a document reader generally, methods of operation of the document reader 100 are discussed. A user, such as a cashier at a business, places a document onto the surface 106 of the document bed 102. The document, such as a check, is detected by the activation sensor 118 as it passes over the document. The activation sensor 118 activates fans 110, causing the Bernoulli effect holding the document to the surface 106. The activation sensor 118 also activates the contact image sensor 114 and the magnetic character reader 116, allowing those components to scan the various portions of the document passing by. Scanning/reading is complete at the end of the document, and the activation sensor 118 detects the end of the document, deactivating the contact image sensor 114, magnetic character reader 116, radial encoder 120, and fans 110. The scanned information can be stored in a memory of the reader 100, or can be communicated to an external computing system by way of any of a number of conventional communication protocols and interfaces, for communication to a financial institution.

Although the document reader 100 is shown as a manually operated scanning device, additional embodiments consistent with the present disclosure may incorporate an optical movement detection system in a variety of other scanners or image recognition devices. Flatbed scanners or other systems may incorporate an optical movement feedback mechanism in accordance with the present disclosure for generating images or text, in conjunction with the image detection sensors incorporated in such devices.

The above specification, examples and data provide a complete description of the manufacture and use of the composition of the invention. Since many embodiments of the invention can be made without departing from the spirit and scope of the invention, the invention resides in the claims hereinafter appended.

1-23. (canceled)

24. An apparatus, comprising:
a document bed having:
a thickness extending between an external, upper document positioning surface and an external, lower mounting surface, and
a plurality of perforations that extend through the thickness of the document bed from the external, upper document positioning surface to the external, lower mounting surface for permitting fluid-flow through the document bed;
means for creating a pressure differential that results in drawing of air through the plurality of perforations from the external, upper document positioning surface and toward the external, lower mounting surface for retaining a document adjacent the external, upper document positioning surface, wherein the means is mounted to the external, lower mounting surface of the document bed; and
means for
detecting arrangement of the document upon the external, upper document positioning surface of the document bed, and
subsequently communicating an activation signal to the means for creating a pressure differential, wherein the means for detecting is communicatively-coupled to the means for creating.

25. The apparatus of claim 24, further comprising
a slider bar mounted along the length of the document bed.

26. The apparatus of claim 25 further comprising
a scanner module mounted to the slider bar, the scanner module manually slidable along the length of the document bed.

27. The apparatus of claim 26, wherein the scanner module includes
a contact image sensor.

28. The apparatus of claim 26, wherein the scanner module includes
a magnetic character reader.

29. The apparatus of claim 24, further comprising
means for computing speed of movement of the scanner module, wherein the means for computing includes
a radial encoder mounted within the scanner module.

30. The apparatus of claim 24, further comprising
an activation sensor within the scanner module.

31. The apparatus of claim 24, wherein the external, upper document positioning surface includes
a high-friction surface.

32. The apparatus of claim 24, wherein the external, upper document positioning surface includes
a rubber surface.

33. The apparatus of claim 24, wherein the means for creating a pressure differential includes
a fan.

34. A method, comprising the steps of:
operating a manual check scanner by:
placing a document on an external, upper document positioning surface of a document bed, the document bed forming a plurality of perforations;
sliding a scanner module along the document bed;
activating at least one fan that is mounted to an external, lower mounting surface of the document bed in response to the sliding step for
drawing air: (1) from about the external, upper document positioning surface, (2) into the document bed by way of the plurality of perforations, and (3) through the plurality of perforations extending through an entire thickness of the document bed, wherein the thickness of the document bed is bound by the external, upper document positioning surface and the external, lower mounting surface, and (4) out of the document bed at the external, lower mounting surface for
maintaining the document on the external, upper document positioning surface.

35. The method of claim 34, further comprising the steps of:
activating a scanner module and
scanning at least a portion of the document.

36. The method of claim 35, wherein scanning at least a portion of the document includes the step of
scanning one or more magnetic characters with a magnetic character reader.

37. The method of claim 35, wherein scanning at least a portion of the document includes the step of
scanning an image of the document with a contact image sensor.

38. The method of claim 35, further comprising the step of
computing the speed of movement of the scanner module with a radial encoder.

39. An apparatus, comprising:
a manually-operable check scanner including:
a document bed having an external, upper check positioning surface and an external, lower mounting surface, wherein the document bed includes a thickness extending between the external, upper check positioning surface and the external, lower mounting surface, wherein the document bed forms a plurality of perforations extending entirely through the thickness of the document bed from the external, upper check positioning surface to the external, lower mounting surface for permitting fluid communication through the entire thickness of the document bed from the external, upper check positioning surface to the external, lower mounting surface;
means for creating a pressure differential for: (1) drawing air from about the external, upper check positioning surface, (2) into the document bed by way of the plurality of perforations and (3) through the plurality of perforations extending through the entire thickness of the document bed and (4) out of the document bed at the external, lower mounting surface for holding a document substantially adjacent to the external, upper check positioning surface, wherein the means is mounted to the external, lower mounting surface of the document bed, wherein the external lower mounting surface is opposite the external, upper check positioning surface, wherein the means includes at least one fan;
means for
detecting arrangement of the document upon the external, upper check positioning surface of the document bed, and
subsequently communicating an activation signal to the means for creating a pressure differential, wherein the means for detecting is communicatively-coupled to the means for creating;
a slider bar mounted along the length of the document bed; and
a scanner module mounted to the slider bar, the scanner module manually slidable along the length of the document bed.

40. The apparatus of claim 39, wherein the scanner module includes
a contact image sensor.

41. The apparatus of claim 39, wherein the scanner module includes
a magnetic character reader.

42. The apparatus of claim 39, further comprising
mean for computing a speed of movement of the scanner module, wherein the means for computing includes a radial encoder mounted within the scanner module.

43. The apparatus of claim 39, further comprising
an activation sensor within the scanner module.

44. The apparatus of claim 39, wherein the external, upper check positioning surface includes
a high-friction surface.
